(19) United States
(12) Patent Application Publication
(10) Pub. No.: US 2017/0046158 A1
(43) Pub. Date: Feb. 16, 2017

(54) DETERMINING PREFETCH INSTRUCTIONS BASED ON INSTRUCTION ENCODING

(71) Applicant: QUALCOMM Incorporated, San Diego, CA (US)

(72) Inventors: Luke YEN, Raleigh, NC (US); Michael William MORROW, Wilkes-Barre, PA (US); Thomas Philip SPEIER, Wake Forest, NC (US); James Norris DIEFFENDERFER, Apex, NC (US)

(21) Appl. No.: 14/827,245

(22) Filed: Aug. 14, 2015

(51) Int. Cl. G06F 9/38; G06F 9/30

(52) U.S. Cl. CPC G06F 9/3802; G06F 9/30043

(57) ABSTRACT

Systems and methods for identifying candidate load instructions for prefetch operations based on at least instruction encoding of the load instructions, include an identifier based on a function of at least one or more fields of a load instruction and optionally, a subset of bits of the PC value of the load instruction, wherein the one or more fields exclude a full address or program counter (PC) value of the load instruction. Prefetch mechanisms, including a prefetch table indexed by the identifier, can determine whether the load instruction is a candidate load instruction for prefetching load data, based on the identifier. The function may be a hash, a concatenation, or a combination thereof, of one or more bits of the one or more fields. The fields include one or more of a base register, a destination register, an immediate offset, an offset register, or other bits of instruction encoding of the load instruction.

### FIELD OF DISCLOSURE

Disclosed aspects relate to prefetch operations in processing systems. More specifically, exemplary aspects relate to identifying candidate load instructions for prefetching, based on an identifier formed from at least one or more fields of the load instruction's encoding.

### BACKGROUND

In order to meet the ever-increasing demands of processing speeds, modern processing system designs include various techniques to reduce bottlenecks in instruction processing. Prefetching mechanisms can be implemented to fetch instructions and data ahead of time. Thus, load data (e.g., for a load instruction) can be fetched and placed in a data cache, for example, before a demand for the load data arises. This way, when the data cache is accessed upon the load instruction being executed, the load data will already be in the data cache, and so a data cache miss can be avoided. Accordingly, efficient prefetching mechanisms can reduce the costs (e.g., in terms of cycle time and power) of servicing cache misses and improve processing speeds by reducing bottlenecks created by cache misses. Prefetch mechanisms can be similarly implemented for prefetching data or instructions, ahead of their demand, into any other memory structure (e.g., a register file), or any cache (e.g., an instruction cache) or cache level, from a backing memory structure.

Conventional prefetch mechanisms may use various prefetch algorithms for identifying candidates (e.g., load instructions) for which prefetch operations may be performed. For example, in the case of data prefetch operations, prefetch algorithms may identify a pattern amongst addresses from which data values are fetched, or addresses for which data fetch requests are generated by a processor. For example, the prefetch algorithms may identify that a particular load instruction, over the course of repeated execution, may generate data fetch requests for data values at addresses which are separated by a regular spacing. This regular spacing between two adjacent addresses from which data values are to be fetched, is referred to as a stride. Any two addresses from which data values are to be fetched for a particular load information may be an integer multiple of the stride, and may be referred to as a distance.

In further detail, in a first instance of execution of the load instruction, a data fetch request for a data value at a first address may be generated by the processor. In a second instance of execution of the load instruction, a data fetch request for a data value at a second address may be generated, wherein the second address may be calculated based on the stride and distance, given the first address. Thus, a prefetch mechanism may store prefetch information such as the first address (or any base address), stride, distance, etc., in a storage medium such as a prefetch table, as known in the art. During program execution, if the load instruction is identified (e.g., at a particular instance), the prefetch mechanism may access the prefetch table to calculate an address (e.g., based on the prefetch information stored therein) from which a data value (load data) may need to be prefetched for a future instance of the load instruction. The prefetch mechanism may then prefetch the load data for the future instance of the load instruction and place it in a data cache (or other memory structure). Thus, when the future instance of the load instruction is identified during program execution, corresponding load data will already be available in the data cache, and thus, a cache miss can be avoided.

Identifying whether a particular load instruction is a candidate for prefetching (e.g., identifying whether corresponding prefetch information is stored in the prefetch table) is conventionally based on the address or PC value of the load instruction. Thus, the prefetch information for a load instruction with a particular PC value may be stored in a corresponding entry of the prefetch table, wherein the entry may be indexed and accessed using the PC value of the load instruction.

However, the address or PC value of the load instruction may not be easily available or convenient to use by the prefetch mechanism. This is because in conventional designs of processing systems, the prefetch mechanisms may be physically located close to a load/store unit used for fetching data, in order to allow the prefetch mechanisms to use the load/store unit for prefetching data for candidate load instructions. Specifically, the prefetch table (indexed and accessed by the PC value) may be located close to the load/store unit. The PC value of instructions (including load instructions) may be available from an instruction fetch unit which fetches the instructions. The instruction fetch unit may be physically located closer to an instruction cache. The locations of the instruction fetch unit and the load/store unit or prefetch table may be separated by a significant distance on a semiconductor die or chip on which the processing system is integrated. Thus, the prefetch mechanisms, which rely on the PC values to identify candidate load instructions for which prefetch operations may be performed, may not have easy access to the PC values of instructions. In order to provide the prefetch mechanisms with access to the PC values, long wires or nets may need to be specially provided to carry the PC values from a front-end of the processing system (e.g., comprising the instruction fetch unit) to a back-end of the processing system (e.g., comprising the load/store unit, prefetch mechanisms, etc.) The long wires incur delays and consume power. Routing the long wires from the front-end to back-end also incurs design challenges and accompanying costs and complexities.

Accordingly, it is desirable to avoid the aforementioned limitations seen in conventional prefetch mechanisms.

### SUMMARY

Exemplary aspects of the invention are directed to systems and methods for identifying candidate load instructions for prefetch operations based on at least instruction encoding of the load instructions. A hash encoding block is provided in a processor, to form an identifier based on a function of at least one or more fields of a load instruction, wherein the one or more fields exclude a full address or program counter (PC) value of the load instruction. Prefetch mechanisms, including a prefetch table indexed by the identifier, are configured to determine whether the load instruction is a candidate load instruction for prefetching load data, based on the identifier. The function is a hash, a concatenation, or a combination thereof, of one or more bits of the one or more fields. The fields comprise one or more of a base register, a destination register, an immediate offset, an offset register, or other bits of instruction encoding of the load instruction. In some aspects, the identifier can be further based on a function of a subset of bits of the PC value of the load instruction.

For example, an exemplary aspect relates to a method of data prefetching, the method comprising forming an identifier based on a function of at least one or more fields of a load instruction, wherein the one or more fields exclude a full address or program counter (PC) value of the load instruction, and determining whether the load instruction is a candidate load instruction for prefetching load data, based on the identifier.

Another exemplary aspect is directed to an apparatus comprising a hash encoding block configured to form an identifier based on a function of at least one or more fields of a load instruction, wherein the one or more fields exclude a full address or program counter (PC) value of the load instruction, and a prefetch mechanism configured to determine whether the load instruction is a candidate load instruction for data prefetch, based on the identifier.

Yet another exemplary aspect is directed to an apparatus comprising means for forming an identifier based on a function of at least one or more fields of a load instruction, wherein the one or more fields exclude a full address or program counter (PC) value of the load instruction, and means for determining whether the load instruction is a candidate load instruction for prefetching load data, based on the identifier.

Yet another exemplary aspect is directed to a non-transitory computer-readable storage medium comprising instructions executable by a processor, which when executed by the processor cause the processor to perform operations for data prefetching, the non-transitory computer-readable storage medium comprising code for forming an identifier based on a function of at least one or more fields of a load instruction, wherein the one or more fields exclude a full address or program counter (PC) value of the load instruction, and code for determining whether the load instruction is a candidate load instruction for prefetching load data, based on the identifier.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a conventional processing system.

FIG. 2 illustrates an exemplary processing system comprising prefetching mechanisms according to aspects of this disclosure.

FIG. 3 illustrates a flow chart representing a method of processing instructions according to exemplary aspects.

FIG. 4 illustrates an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In exemplary aspects of this disclosure, the aforementioned problems associated prefetch mechanisms which rely on addresses or program counter (PC) values for identifying candidate load instructions, are mitigated. Rather, an exemplary alternative identifier is formed for identifying candidate load instruction, wherein the identifier does not comprise the full address or PC value of the load instruction. Instead, the identifier can be formed (at least partially) from the load instruction's encoding. For example, one or more fields of a load instruction, such as a base register, a destination register, an immediate offset value, an offset register, etc., may be used to create the identifier. While in some cases no bits of the PC value are used for creating the identifier, in some other cases, it is possible to also use a subset (e.g., a small portion of the PC value) in addition to the one or more fields of the instruction, for creating the identifier. A hash function of the one or more fields (and, where applicable, a subset of bits of the PC value) may be used to create the identifier, such that the identifier is associated with and can identify the candidate load instruction. The hash may be a concatenation, an exclusive-or (XOR) function, or any other combination of the bits used to form the identifier.

By using the alternative identifier based on the instruction encoding, rather than the PC value alone of load instructions, exemplary prefetch mechanisms can avoid the long paths and delays associated with relying on only the PC value for identifying candidate load instructions. Exemplary prefetch mechanisms may initiate and perform prefetch operations based on identifying candidate load instructions using the exemplary identifier.

Although exemplary aspects are described in regard to prefetching, it will be understood that an exemplary identifier formed from an instruction's encoding (e.g., a function of one or more fields of the instruction, rather than only the PC value of the instruction) can be used in other applications. (For example, some applications may track instructions which cause errors, faults, or exceptions in programs. The tracked information may be useful in determining the corrective measures, such as exception handlers, to be implemented. Rather than identifying the instructions based on their full address or PC value alone, an identifier formed from an instruction's encoding may also be used in these applications.)

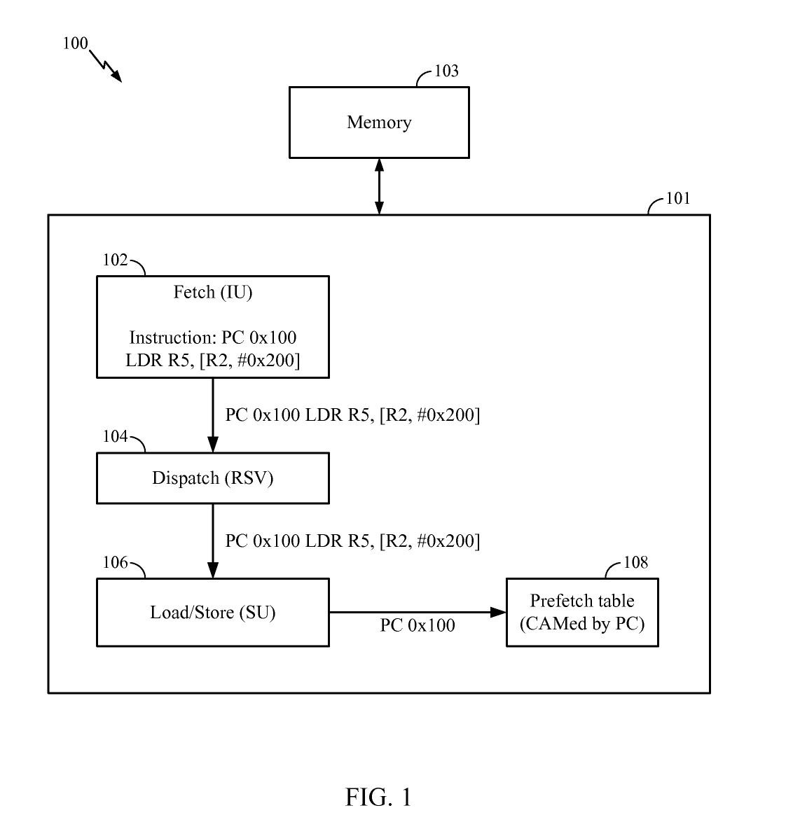

With reference now to FIG. 1, a conventional processing system 100 is shown, with processor 101 coupled to memory 103. Only relevant portions of processor 101 are illustrated for the sake of this discussion, but it will be understood that processor 101 can be any conventional general purpose processor or special purpose processor. Memory 103 can include one or more memory structures such as instruction caches, data caches, multiple levels of caches such as L1, L2, L3 caches, etc., and backing storage or main memory such as a dynamic random access memory (DRAM), etc. Some or all or memory 103 can be integrated on the same chip as processor 101, integrated on a separate chip or block, or any combination thereof.

For the purposes of this discussion, processor 101 is shown to comprise instruction fetch unit (IU) 102, dispatch unit 104, load store unit (SU) 106 and prefetch table 108. Instruction fetch unit 102 is configured to fetch one or more instructions on each cycle of a clock (for example, from an instruction cache, which may be part of memory 103 or may be part of another structure not explicitly shown) to be executed in an execution pipeline or execution engine (not explicitly shown) of processor 101. Instruction fetch unit 102 fetches instructions based on their addresses or program counter (PC) values. Thus, instruction fetch unit 102, which forms a front-end of the execution engine of processor 101, has access to the PC values of instructions. Instruction fetch unit 102 may be physically located close to the instruction cache in the design or layout of a semiconductor die or integrated circuit on which processor 101 is integrated, in order to reduce the wire lengths and associated delays between the instruction cache and instruction fetch unit 102.

Dispatch unit 104 can receive fetched instructions from instruction fetch unit 102 and stage the instructions for dispatch. Dispatch unit 104 can comprise a reservation station (RSV) where instructions are held and hazards, if any, are resolved (e.g., with register renaming) before the instructions are dispatched to the execution engine.

Load/store unit 106 may be part of the execution engine of processor 101, configured to execute load/store instructions. Load/store unit 106 may receive the load/store instructions and perform operations for one or more cache lookups, service misses, access main memory as needed, etc., for processing the load/store instructions. Accordingly, load/store unit 106 may serve as a back-end in the processing of load/store instructions. To improve efficiency and speed, load/store unit 106 may be physically located close to data caches, and other backing memory structures in the design or layout of the semiconductor die or integrated circuit on which processor 101 is integrated. Thus, it is possible for load/store unit 106 to be physically separated from instruction fetch unit 102 by a significant distance.

Prefetch table 108 may be part of a prefetching mechanism for prefetching data based on identifying candidate load instructions. Prefetch table 108 may comprise prefetch information such as a base address, stride, distance, etc., for candidate load instructions. At a particular instance, if a candidate load instruction is identified, data for one or more future instances of the candidate load instruction can be prefetched using the prefetch information. The data for candidate load instructions can be prefetched from a backing memory structure and placed in a data cache (or other on-chip memory structure such as a register file, for example). The prefetching mechanisms may use load/store unit 106 to fetch the prefetch data for candidate load instructions, and therefore, prefetch table 108 may be physically located close to load/store unit 106. Prefetch table 108 may be implemented as a content addressable memory (CAM), which can be indexed using PC values of instructions. The PC value of a load instruction received by load/store unit 106 can be used to look-up prefetch table 108 to determine whether prefetch information for the load instruction exists in prefetch table 108. If prefetch information for the load instruction exists in an entry of prefetch table 108, there is a hit in the prefetch table and the load instruction is treated as a candidate load instruction for prefetching. Determining that the load instruction is a candidate load instruction can cause prefetch operations to be initiated for prefetching data, using the prefetch information obtained from the entry of prefetch table 108 which caused a hit for the PC value of the load instruction.

Thus, the prefetching mechanisms rely on the PC values of instructions fetched by instruction fetch unit 102 for identifying candidate load instructions for prefetching data. Relevant steps involved in the processing of an example load instruction (with instruction encoding or assembly code “PC 0x100 LDR R5, [R2, #0x200]”) as it is executed in the processing engine or processor 101 are shown in FIG. 1. The load instruction's instruction encoding includes “LDR” which stands for load-from-a-register. The load instruction LDR has an address or PC value of 0x100. The load instruction LDR is used to load a value from an address specified in register R2 (of a register file of processor 101, not illustrated) added with an offset value given by the immediate field “0x200” in the illustrated instance of the load instruction. In different instances of the load instruction LDR at PC 0x100, the immediate field can have different offset values (which, as can be recognized, may control the stride of addresses from which data values are prefetched in different instances of the load instruction).

As shown, the PC value 0x100, as well as the rest of the fields of instruction LDR R5, [R2, #0x200] are sent to dispatch unit 104, and from there to load/store unit 106. The load instruction LDR is executed in load/store unit 106 by reading the value of the base register R2, adding an immediate or offset value 0x200 to that value, fetching data found at an address equal to the sum of the address in R2 and 0x200 and loading the fetched data in the destination register R5 of the register file.

Prefetch table 108 is provided with the value of PC 0x100 which has been passed down from instruction fetch unit 102, for determining whether the load instruction LDR at PC 0x100 is a candidate load instruction for prefetching, i.e., whether prefetch table 108 comprises prefetch information for load instruction LDR at PC 0x100.

The physical distance between instruction fetch unit 102 and load store unit 106/prefetch table 108 can be significantly large. The number of bits used to represent the entire PC value (e.g., 0x100 in the above example) for instructions may be significantly large (e.g., 64-bits wide in conventional implementations), which means that a corresponding number of wires are used in carrying the entire PC value of 0x100 from instruction fetch unit 102 to prefetch table 108, leading to related increases in power consumption, routing complexity, costs, etc.

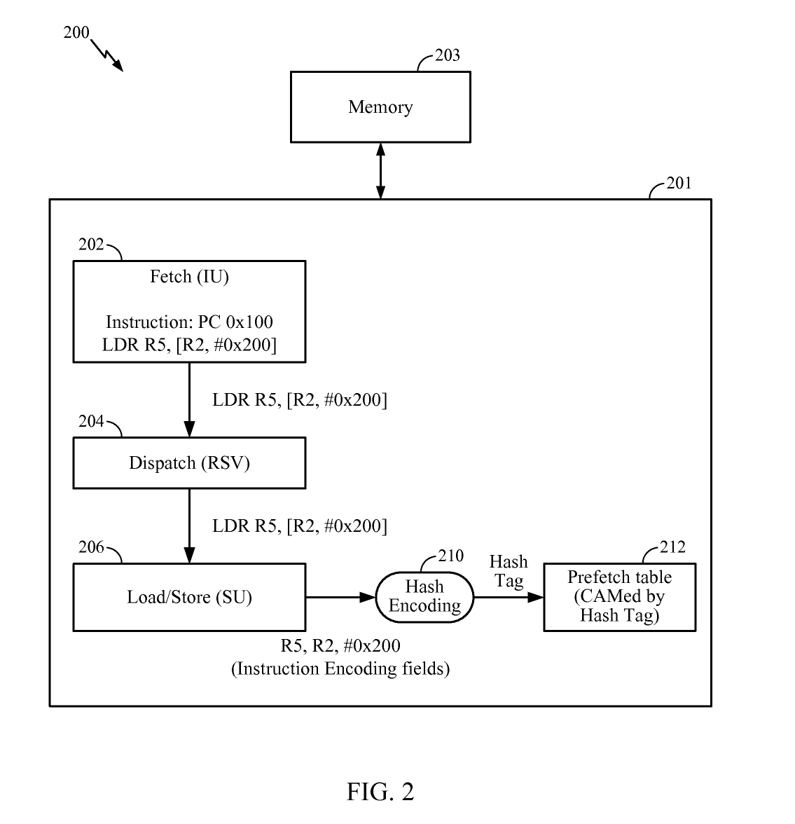

With reference now to FIG. 2, an exemplary processing system 200 is illustrated. Processing system 200 is similar in some aspects to conventional processing system 100, and like reference numerals have been used to identify similar components of processing systems 100 and 200. Thus, processing system 200 also includes memory 203 (which may be similar to memory 103 described with respect to FIG. 1), and processor 201 in communication with memory 203. Processor 201 also includes an execution engine for executing instructions which may be fetched, for example, from an instruction cache of memory 203. Only relevant details of the execution engine of processor 201 have been illustrated, and these include instruction fetch unit 202 (which is similar to instruction fetch unit 102 of FIG. 1), dispatch unit 204 (which is similar to dispatch unit 104 of FIG. 1), and load/store unit 206 (which is similar to load/store unit 106 of FIG. 1). The execution engine of processor 201 also includes hash encoding block 210 and prefetch table 212 which will be described further below.

In processor 201, prefetching mechanisms need not rely on PC values of instructions for identifying candidate load instructions for prefetching. Rather, an exemplary alternative identifier is formed for identifying candidate load instructions, wherein the identifier may not involve the full address or PC value of the load instruction (although in optional aspects, a subset of the bits of the PC value can also be used in creating the identifier). The exemplary identifier is formed from at least the load instruction's encoding. For example, at least one or more fields of a load instruction, such as a base register, a destination register, an immediate offset value, an offset register, etc., are used to create the alternative identifier.

Considering the same load instruction discussed with reference to FIG. 1 above, aspects related to the exemplary identifier will be illustrated. As shown in FIG. 2, the load instruction LDR, with instruction encoding or assembly code “PC 0x100 LDR R5, [R2, #0x200]” is received by instruction fetch unit 202. However, in the execution of the load instruction, the entire PC value 0x100 of the load instruction LDR is not provided to dispatch unit 204. The entire PC value 0x100 is also not provided to load/store unit 206. Rather, in the illustrated example, only the instruction encoding LDR R5, [R2, #0x200] is provided to dispatch unit 204 and load/store unit 206. Dispatch unit 204 and load/store unit 206 do not need the PC value 0x100 to execute the load instruction, and so the execution of the load instruction proceeds in a conventional manner in load/store unit 206 (e.g., by reading the value of register R2, adding 0x200 to that value and fetching data found at an address equal to the sum of the address in R2 and 0x200).

Although not illustrated, alternative aspects are possible within the scope of this disclosure, wherein a subset of bits of the PC value can optionally also be used in addition to the above-described instruction fields for forming the identifier. The subset of bits may be a small number or a small portion of the PC value. For example, four of the 64-bits of the PC value (e.g., PC [5:2]) may be used in addition to the load instruction's encoding in forming the identifier.

Thus, the prefetching mechanisms used by processor 201 may not be supplied with the entire PC value. Rather, the prefetching mechanisms of processor 201 may receive at least some bits of the instruction encoding of the load instruction LDR R5, [R2, #0x200]. The instruction encoding for the load instruction LDR R5, [R2, #0x200] comprises one or more fields, including the register fields R5 and R2 and the immediate offset field 0x200. In exemplary aspects of this disclosure, at least a combination of bits of these fields is seen to be specific to the load instruction LDR R5, [R2, #0x200] found at the PC value 0x100. Thus, at least a combination of bits of the one or more fields of the load instruction is used to identify load instruction LDR at PC value 0x100. Optionally, a small subset of bits, but not all bits, of PC value 0x100 may also be used in conjunction with the combination of bits of the one or more fields of the load instruction in identifying the load instruction. As previously discussed, a PC value may comprise 64-bits for example. However, the number of bits used for the instruction's encoding (e.g., an operation code or op-code of the instruction), and the one or more fields, such as, register fields R5 and R2 and the immediate offset field of the load instruction LDR R5, [R2, #0x200] may be as low as 20-bits or less. Further, it will be noted that even in some conventional aspects, some number of bits (e.g., 20-bits) of the instruction's encoding and bits of one or more fields of the load instruction may be provided to load/store unit 206, to enable load/store unit 206 to compute address values from which to fetch load data.

Accordingly, hash encoding block 210 is configured to implement a hash function, which is a combination of at least one or more fields of the instruction's encoding. The hash function may be, for example, a concatenation, an exclusive-or (XOR) function, or any other combination of at least some bits of one or more fields and optionally, a subset of bits of the PC value of an instruction. In the example shown, hash encoding block 210 may create a hash function of at least some bits of the register fields R5 and R2 and the immediate value or offset field 0x200. The output of hash encoding block 210 is an identifier, which is the combination of one or more fields of the load instruction LDR and, optionally, with PC value 0x100.

In some cases, the identifier formed in hash encoding block 210 may be a unique identifier of the load instruction LDR at PC 0x100. In general, the identifier formed in hash encoding block 210 can differentiate between various candidate load instructions for which prefetch information may be stored in prefetch table 212. Therefore, the identifier may be used to index prefetch table 212 to determine if there is a hit, i.e., if prefetch table 212 comprises prefetch information (e.g., one or more of a base address, stride, distance, etc., which can be used to calculate addresses for prefetching data corresponding to the load instruction). In this manner, any hash function or encoding or combination of at least one or more fields of candidate load instructions for prefetching, such as one or more of a destination register, base register, immediate value or offset register (e.g., a register which may specify an offset value, rather than the immediate value which provides the offset value in the above example), and optionally, a subset of the bits of the PC value, can be used to identify whether prefetch information is present in prefetch table 212 for a load instruction. Determining that prefetch information is present in prefetch table 212 for a load instruction can trigger corresponding prefetch operations for one or more data values at addresses calculated using the prefetch information.

Accordingly, in one example, there may be a hit in prefetch table 212 for the identifier provided by hash encoding block 210. For example, an identifier formed with at least some bits of one the fields of R5, R2, and 0x200 of the load instruction LDR may reveal that prefetch table 212 comprises prefetch information corresponding to the load instruction LDR. Thus, the load instruction LDR may be identified as a candidate load instruction for prefetching. One or more data values for this candidate load instruction can be prefetched from addresses formed by adding stride values to the address provided by the base register R2, in one example. These one or more data values can be prefetched and loaded in a data cache (not shown). In some cases, the calculation may be incorrect because the prefetch algorithms are speculative. Techniques for improving accuracy of the prefetch algorithms are known in the art and are not the focus of this discussion. In exemplary aspects, each time a load instruction received by load/store unit 206 (e.g. during execution of a program) is identified as a candidate load instruction for prefetching, corresponding prefetch information from prefetch table 212 can be used for calculating addresses to prefetch data and corresponding prefetch operations can be initiated.

As previously noted, prefetch table 212 can be implemented as a content-addressable memory (CAM). Load/store unit 206 can access prefetch table 212 based on providing the instruction encoding LDR R5, [R2, #0x200] to hash encoding table 210, obtaining an identifier based on at least the fields R5, R2, and 0x200 (and optionally a subset of bits of the PC value 0x100), and accessing the CAM in prefetch table 212 using the identifier to determine prefetch information, such as stride. In this manner, all bits of the PC value 0x100 of the load instruction need not be used for identifying candidate load instructions or for retrieving prefetched data. Accordingly, delays and power consumption associated with using all bits of the PC values for the above prefetch operations can be mitigated.

It will also be appreciated that an identifier formed by a hash function or combination of one or more fields of an instruction encoding can be used in place of a PC value in identifying instructions for any other operation. As such, exemplary aspects are not limited to prefetch operations.

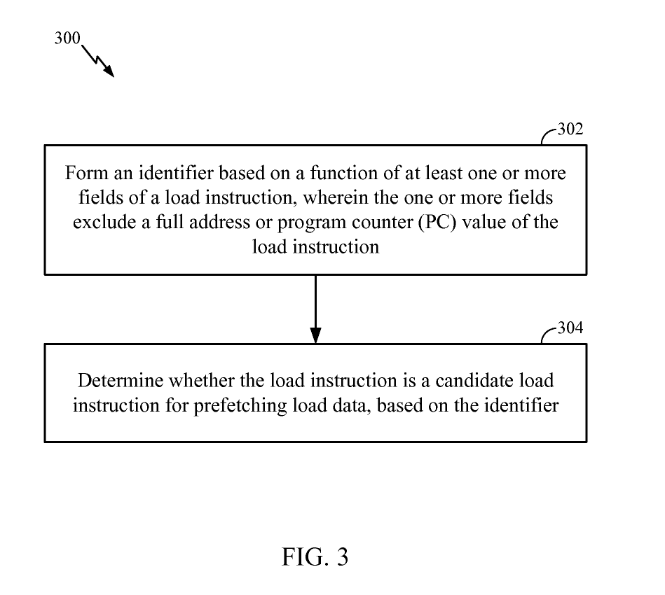

It will be appreciated that exemplary aspects include various methods for performing the processes, functions and/or algorithms disclosed herein. For example, as shown in FIG. 3, method 300 is a method of instruction processing according to exemplary aspects disclosed herein. For example, method 300 pertains to a method of data prefetching (e.g., of candidate load instruction LDR described with reference to FIG. 2).

As shown in Block 302, method 300 comprises forming an identifier based on a function of at least one or more fields of a load instruction, wherein the one or more fields exclude a full address or program counter (PC) value of the load instruction. For example, Block 302 pertains to forming a hash, a concatenation, or a combination thereof, of one or more bits of the at least one or more fields such as a base register (e.g., register R2), a destination register (e.g., register R5), an immediate offset (e.g., immediate value 0x200), an offset register, or other bits of instruction encoding of load instruction LDR R5, [R2, #0x200] in hash encoding block 210 of FIG. 2. In optional aspects, the identifier may further be formed from a function of a subset of bits of the PC value of the load instruction LDR, as noted above.

In Block 304, method 300 comprises determining whether the load instruction is a candidate load instruction for prefetching load data, based on the identifier. For example, Block 304 may pertain to determining if there is a hit in prefetch table 212, i.e., if prefetch table 212 has an entry comprising prefetch information corresponding to the load instruction, using the identifier. The prefetch information can include one or more of a base address, stride, or distance for prefetching load data. If there is a hit in prefetch table 212, one or more addresses for prefetching load data can be calculated based on prefetch information stored in a prefetch table, and one or more data values can be prefetched from the one or more addresses and loaded in a data cache.

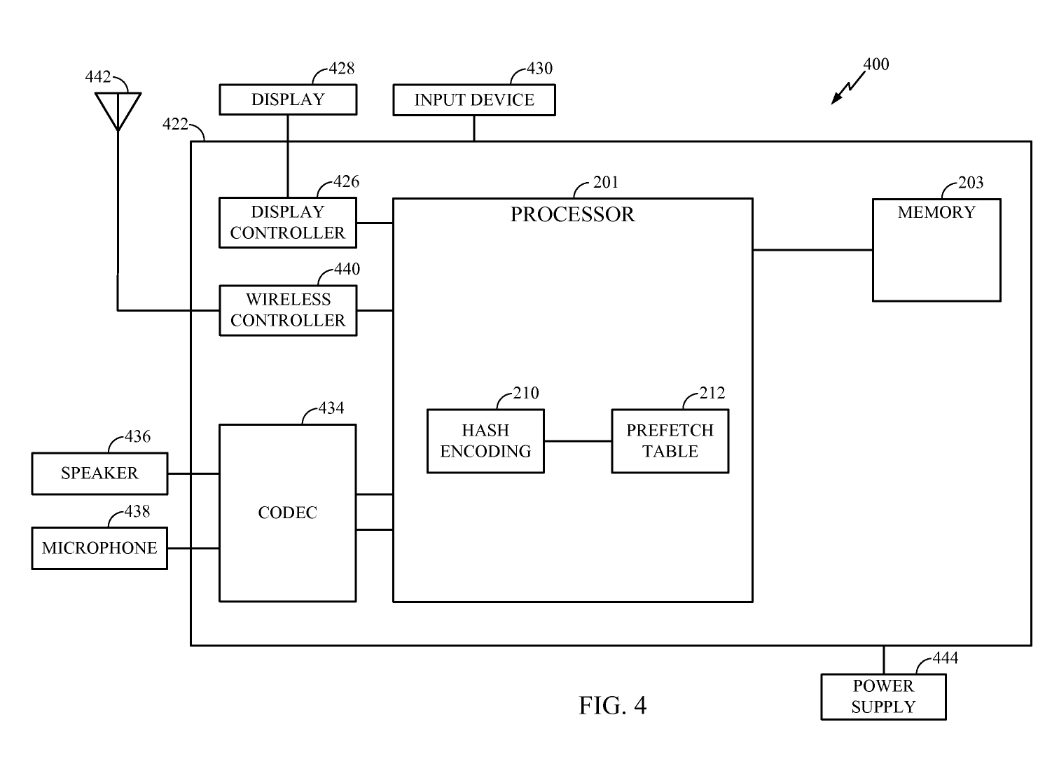

Referring now to FIG. 4, a block diagram of a particular illustrative aspect of computing device 400 configured according to exemplary aspects, is illustrated. Computing device 400 includes processor 201 described with reference to FIG. 2 (with only blocks representing exemplary structures corresponding to hash encoding block 210 and prefetch table 212 shown for the sake of clarity in this representation). Processor 201 may be configured to perform method 300 of FIG. 3 in some aspects. As shown in FIG. 4, processor 201 may be in communication with memory 203, as previously described. Although not shown separately, one or more caches or other memory structures may also be included in computing device 400.

FIG. 4 also shows display controller 426 that is coupled to processor 201 and to display 428. Coder/decoder (CODEC) 434 (e.g., an audio and/or voice CODEC) can be coupled to processor 201. Other components, such as wireless controller 440 (which may include a modem) are also illustrated. Speaker 436 and microphone 438 can be coupled to CODEC 434. FIG. 4 also indicates that wireless controller 440 can be coupled to wireless antenna 442. In a particular aspect, processor 201, display controller 426, memory 203, CODEC 434, and wireless controller 440 are included in a system-in-package or system-on-chip device 422.

In a particular aspect, input device 430 and power supply 444 are coupled to the system-on-chip device 422. Moreover, in a particular aspect, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, processor 201 and memory 203 may also be integrated into a set top box, a music player, a video player, an entertainment unit, a navigation device, a personal digital assistant (PDA), a communications device, a fixed location data unit, a computer, or other similar electronic devices. Further, at least one or more exemplary aspects of computing device 400 may be integrated in at least one semiconductor die.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for determining candidate load instructions for prefetch operations based on a combination of one or more fields of the candidate load instruction. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of data prefetching, the method comprising:
forming an identifier based on a function of at least one or more fields of a load instruction, wherein the one or more fields exclude a full address or program counter (PC) value of the load instruction; and
determining whether the load instruction is a candidate load instruction for prefetching load data, based on the identifier.

2. The method of claim 1, wherein the function is a hash, a concatenation, or a combination thereof, of one or more bits of the at least one or more fields.

3. The method of claim 1, wherein the one or more fields comprise one or more of a base register, a destination register, an immediate offset, an offset register, or other bits of instruction encoding of the load instruction.

4. The method of claim 1, further comprising calculating one or more addresses for prefetching load data based on prefetch information stored in a prefetch table if the load instruction is determined to be a candidate load instruction for prefetching load data.

5. The method of claim 4, wherein the prefetch information comprises one or more of a base address, stride, or distance for prefetching load data.

6. The method of claim 4, further comprising prefetching one or more data values from the one or more addresses and loading the one or more data values in a data cache.

7. The method of claim 5, comprising accessing the prefetch information stored in the prefetch table based on the identifier, wherein the prefetch table comprises a content-addressable memory (CAM) indexed by the identifier.

8. The method of claim 1, further comprising forming the identifier based on a function of a subset of bits of the PC value of the load instruction.

9. An apparatus comprising:
a hash encoding block configured to form an identifier based on a function of at least one or more fields of a load instruction, wherein the one or more fields exclude a full address or program counter (PC) value of the load instruction; and
a prefetch mechanism configured to determine whether the load instruction is a candidate load instruction for data prefetch, based on the identifier.

10. The apparatus of claim 9, wherein the function is a hash, a concatenation, or a combination thereof, of one or more bits of the at least one or more fields.

11. The apparatus of claim 9, wherein the one or more fields comprise one or more of a base register, a destination register, an immediate offset, an offset register, or other bits of instruction encoding of the load instruction.

12. The apparatus of claim 9, further comprising a prefetch table configured to store prefetch information for candidate load instructions for data prefetch.

13. The apparatus of claim 12, wherein the prefetch information comprises one or more of a base address, stride, or distance for data prefetch.

14. The apparatus of claim 12, wherein the prefetch table comprises a content-addressable memory (CAM) indexed by the identifier, wherein the prefetch information for the load instruction is stored in an entry corresponding to the identifier.

15. The apparatus of claim 12, wherein the prefetch mechanism is configured to calculate one or more addresses for data prefetch based on the prefetch information and prefetch one or more data values from the one or more addresses.

16. The apparatus of claim 15, further comprising a data cache configured to store the prefetched one or more data values from the one or more addresses.

17. The apparatus of claim 9, wherein the identifier is further based on a function of a subset of bits of the PC value of the load instruction.

18. The apparatus of claim 9, integrated into a device selected from the group consisting of a set top box, music player, video player, entertainment unit, navigation device, communications device, personal digital assistant (PDA), fixed location data unit, and a computer.

19. An apparatus comprising:
means for forming an identifier based on a function of at least one or more fields of a load instruction, wherein the one or more fields exclude a full address or program counter (PC) value of the load instruction; and
means for determining whether the load instruction is a candidate load instruction for prefetching load data, based on the identifier.

20. The apparatus of claim 19, wherein the function is a hash, a concatenation, or a combination thereof, of one or more bits of the at least one or more fields.

21. The apparatus of claim 19, wherein the one or more fields comprise one or more of a base register, a destination register, an immediate offset, an offset register, or other bits of instruction encoding of the load instruction.

22. The apparatus of claim 19, further comprising means for calculating one or more addresses for prefetching load data based on prefetch information corresponding to the load instruction, if the load instruction is determined to be a candidate load instruction for prefetching load data.

23. The apparatus of claim 22, wherein the prefetch information comprises one or more of a base address, stride, or distance for prefetching load data.

24. The apparatus of claim 19, further comprising means for forming the identifier based on a function of a subset of bits of the PC value of the load instruction.

25. A non-transitory computer-readable storage medium comprising instructions executable by a processor, which when executed by the processor cause the processor to perform operations for data prefetching, the non-transitory computer-readable storage medium comprising:
code for forming an identifier based on a function of at least one or more fields of a load instruction, wherein the one or more fields exclude a full address or program counter (PC) value of the load instruction; and
code for determining whether the load instruction is a candidate load instruction for prefetching load data, based on the identifier.
